(19) United States
(12) Patent Application Publication
(10) Pub. No.: US 2024/0074838 A1
(43) Pub. Date: Mar. 7, 2024

(54) DENTAL IMPLANT

(71) Applicant: SIC invent AG, Basel (CH)

(72) Inventors: Jörg WINTERHOFF, Bonn (DE); Oke JÖRN TANCK, Göttingen (DE); Marcus VON MALOTTKI, Mettmann (DE)

(73) Assignee: SIC invent AG, Basel (CH)

(21) Appl. No.: 18/204,285

(22) Filed: May 31, 2023

(30) Foreign Application Priority Data
Jun. 2, 2022 (EP) 22176986.2

(51) Int. Cl. A61C 8/00

(52) U.S. Cl. CPC A61C 8/0024

(57) ABSTRACT

A dental implant having a prosthetic interface in its cervical region, a core and at least one thread extending from the cervical region to an opposite apical region, the thread having recesses on which a cutting edge for cutting bone is arranged, the respective cutting edge is arranged in the thread direction at the rear side of the recess, wherein the respective recess comprises a cutting area at which the cutting edge is arranged and a compacting area adjacent to the cutting area for compacting bone tissue.

### FIELD OF INVENTION

The invention relates to a dental implant having a prosthetic interface in its cervical region, a core and at least one thread extending from the cervical region to an opposite apical region, the thread having recesses on which a cutting edge for cutting bone is arranged, the respective cutting edge being arranged in the direction of the thread at the rear of the recess.

### BACKGROUND OF INVENTION

Providing a patient with artificial dentures to replace the previously existing natural teeth usually has both aesthetic and medical backgrounds. On the one hand, the impression of a complete set of teeth can be created visually. On the other hand, the absence of teeth can also lead to physical changes such as bone loss in the area of the jaw, displacement or “wandering” of the teeth still present in the direction of the gap created, or extrusion of the opposing teeth.

If a dental implant or dental implant is used as an artificial tooth replacement, it is inserted into the jawbone in the gap created, in particular screwed in, where it grows as firmly as possible into the bone. An abutment is taken up by the implant, which then carries the visible dental prosthesis, such as a crown.

The dental implant typically has a threaded core extending from the cervical area to an opposite apical area. A prosthetic interface of the implant allows connection to artificial dentures such as bridges or crowns.

In the increasingly important immediate restoration of patients, often only a supply of poor-quality bone and/or soft bone is available. Known implants are of limited use in these situations because they do not allow immediate loading after implementation. In soft bone, the trabeculae are very fragile. Known implants with self-tapping geometry do not cut the soft conch cleanly, but crush the fragile structures, which counteracts the achievement of high primary stability.

From EP 3 235 465 B1, a dental implant having a prosthetic interface in its cervical region, a core, and at least one thread extending from the cervical region to an opposing apical region is known, the thread having cutting edges.

EP 2 845 561 A1 describes a self-drilling dental implant with a propeller-like tip. The implant thread has cutting edges.

### SUMMARY OF INVENTION

The invention is therefore based on the object of providing a dental implant which permits particularly reliable primary stability.

This object is solved according to the invention in that the respective recess has a cutting region at which the cutting edge is arranged and a compaction region adjacent to the cutting region for compacting bone tissue. Advantageous embodiments of the invention are the subject of the subclaims.

The invention is based on the consideration that immediate restoration of patients with dental implants is becoming increasingly important. In these cases, the specific implantation area in the jaw is often suboptimal, for example due to excessively soft bone tissue or bone tissue in poor condition. A dental implant that can be successfully used here must take these conditions into account in its design and enable a reliable restoration. The dental implant should generate a high primary stability to enable immediate loading.

As has now been recognized, these requirements can be met by design and functional features in the thread and cervical area. In particular, the torque during insertion, which correlates very strongly with primary stability, should be able to be applied in a targeted manner directly during insertion of the implant. The implant should therefore itself, without the use of further tools, allow bone processing during insertion via constructive functional elements, which on the one hand can cause bone compaction in cases of relatively soft bone and on the other hand can cause loosening of the bone in the thread area in cases of very hard bone.

For this purpose, the thread path of the implant is interrupted once or several times around its circumference. On one side of the interruption (the side working against the bone in the direction of insertion) there is a defined rounded geometry (compaction zone) with which the bone is gently compacted by being pressed outward to the wall of the implant bed and between the threads and compacted. Separated by the thread interruption/recess, there is a cutting zone on the opposite side, which does not become active on the bone in the normal direction of insertion rotation, but only pre-cuts the slowly receding bone in the mode of a tap when the direction of rotation is reversed, and then enables easier insertion when the regular direction of rotation is returned.

In this novel way, the practitioner can selectively cause bone compaction or loosening without additional tools by choosing the direction of rotation of the implant itself during insertion according to bone quality.

The bone is compacted in a defined manner towards the exterior, i.e., normal to the contour towards the outside, i.e., towards the thread tips, and is displaced into the thread valleys and to the thread flanks, whereby on the one hand a high degree of bone/implant contact is achieved, and on the other hand a further improvement in terms of the stable hold of the implant directly after insertion in the bone is achieved, particularly due to the pre-compacted bone. The special method of bone compaction increases the so-called primary stability, which is particularly important for immediate restoration. Here, the implant is subjected to unavoidable loads immediately or after a shorter period of time due to masticatory function.

The respective recess has two opposite functional sides, which are used depending on the direction of rotation and exert different effects (compacting in the insertion direction and cutting in the opposite direction) on the bone. The bone tissue is gently condensed on the compaction area during screw insertion.

The thread direction corresponds to the implant insertion direction. Viewed in the direction of rotation, the cutting edge is located at the rear of the cutting area. This advantageously corresponds to the area of the cutting region that first passes a spatially fixed imaginary position in the bone during insertion without cutting it. The cutting edge is preferably arranged at the end of the cutting region which is furthest away from the compaction region.

The cutting edge is oriented in such a way that it does not cut during insertion and cuts the bone tissue when the implant is rotated in the opposite direction to the insertion direction. The angle of the cutting edge advantageously correlates substantially with the angle of the channel-shaped chip space.

Adjacent to the special shape of the compaction area, in particular separated by the recess or the flute, in particular continuously curved in the opposite direction, is a cutting area. This cutting region has the function that when the implant is turned back, these cutting edges reduce bone pushing back into the recess after displacement and thus reduce bone compaction. This function is particularly important if too high a screw-in torque occurs interoperatively when inserting the implant, which would compress the bone too much, or if the bone in the structures of the implant bed has too high a hardness, which would adversely affect implant placement.

It is now possible for the surgeon to optimally control the desired screw-in torque or the primary stability of the implant without any additional tools or procedures, depending on the surgical conditions. By screwing in clockwise, the compaction areas of the flutes take effect, and by briefly turning back, the oppositely acting cutting areas come into operation.

Advantageously, the compaction area is rounded and, viewed perpendicular to a central axis of the dental implant from a point of maximum recess depth closest in radial direction to the central axis, has an S-curve/S-shaped curve or sinusoidal curve starting from the concavity there. From the transition of the concave part of the S-curve near the mid-axis to the convex part—running towards the outside of the implant—the curve preferably takes the form of a half-parabola, the slope of which decreases harmoniously over the course towards the outside. This geometry permits bone-protecting degressive displacement (decreasing over the course), i.e., for the same arc traversed when screwing in the implant, the bone is displaced outward and compacted more quickly in the region of the greater slope than in the region of the smaller slope. This results in the physiological advantage of bone protection, since the initially softer bone is progressively pre-compacted, and subsequently the bone reaches its final compaction locally in a gentle, degressive manner due to the decreasing slope.

The compaction area is thus preferably characterized by the specific rise from the lowest point of the recess circumference to the thread tip in the form of a degressively rising semi-parabolic geometry, which ensures gentle displacement of the bone during the implant insertion process. This is rounded and characterized by the specific slope from the lowest point of the recess circumference to the thread tip in the form of a degressively rising, preferably semi-parabolic geometry, which ensures gentle displacement of the bone during the insertion process of the implant. The slope runs in a defined degressive manner from the depth of the recesses outwards (towards the thread tips), so that for the same circular arc traversed when screwing in the implant, the bone is displaced outwards and compacted more quickly in the region of the greater slope than in the region of the smaller slope. The compaction area advantageously follows the cutting area in a convex/concave transition to the external thread. The outlet of the concave compaction zone can be tangential or formed at an angle <45°.

The slopes of the S-curve, in particular of a half-parabola contained therein, can vary over the course of the implant length from apical to coronal depending on the locally desired displacement volume and the intensity of the displacement.

The mode of action of the flutes should advantageously change in the vertical height of the implant body. Thus, at the apical end of the implant, a deep and radially extensive interruption area is advantageous, while in the coronal upper region of the implant, the flutes are less deep and radially extensive. The decisive factor for the advantageous design is balanced construction with sufficient mechanical stability due to a coronal thread core that is as solid as possible and preferably has the internal geometry of the implant interface to the prosthetic components.

Furthermore, as already explained, the bone hardness is usually softer towards the apical end of the implant. In this lower zone, the strongest function of compaction should take place by means of strongly pronounced flutes, which then decrease towards the coronal. As the cross-section of the thread core increases in the coronal direction, additional compaction of the bone takes place. As the bone becomes increasingly harder in this zone, the compressive compaction course should increasingly change to a cutting course.

The transition from compaction to cutting occurs continuously via the apical S-curve, which increasingly becomes an arc curve in the coronal direction. This advantageous course makes it possible to achieve high mechanical stability while at the same time optimizing the displacement and cutting function in the respective bone zone. In addition, the variations in the gradient of the displacing components described above allow better consideration of the different bone densities occurring in these zones, from apical (generally spongy/soft) to coronal (generally denser/harder).

The opening angle of the respective recess is preferably an acute angle and is preferably between 40° and 90°, in particular 56°. An opening angle that is too small would result in a very short S-curve, in which the bone would be insufficiently compacted as a result of the inertia of the elastic trabecular structure. An angle that is too large would lengthen the S-curve, thereby interrupting the radial external threads too much in their guiding and supporting function. Therefore, the appropriate opening angle in the respective implant zone is particularly important. The opening angle is the same on one side in the compressing geometry as it is on the opposite side in the cutting geometry and is therefore a constructive part of the reversal effect of the implant insertion process, namely compaction in the insertion direction, cutting in the opposite direction.

The compaction area is rounded and has a positive, monotonically decreasing slope perpendicular to a central axis of the dental implant, viewed from a point of maximum recess depth closest in radial direction to the central axis. This geometry allows bone-sparing degressive displacement (decreasing over the course), i.e., for the same arc traversed when screwing in the implant, the bone is displaced outward and compacted more quickly in the region of the larger slope than in the region of the smaller slope. This results in the physiological advantage of bone protection, since the initially softer bone is progressively pre-compacted, and subsequently the bone reaches its final compaction locally in a gentle, degressive manner due to the decreasing slope.

The cutting area is advantageously rounded and, viewed perpendicular to a central axis of the dental implant, has a contour with a constant radius from a point of maximum recess closest in the radial direction to the central axis in the direction of the cutting edge, which merges into a straight section. In this way, balanced cutting efficiency and tissue protection are optimized in conjunction with the deflective chip evacuation and chip collection continuing from the cutting angle.

The recess with cutting area and compaction area preferably has an essentially sinusoidal wave-shaped contour. The geometry of this contour combines the above-described function of bone compaction and displacement in the corresponding direction of rotation, as well as the cutting function and chip removal or displacement also described above in the opposite direction of rotation.

The angle of the respective cutting edge in relation to the tangent of the outer diameter of the thread is advantageously between 70-150°. In this way, depending on the desired cutting performance at the respective position of the implant, a gradation between aggressive cutting and gentler compaction is made possible. The cutting area has the function that when the implant is turned back, these cutting edges reduce the bone and thus reduce bone compaction.

The action of the cutting edges should advantageously change in the vertical height of the implant body. Thus, at the apical end of the implant, a deep and radially extensive interruption area is advantageous, while in the coronal upper region of the implant, the flutes are less deep and radially extensive. The decisive factor for the advantageous design is a balanced construction with sufficient mechanical stability due to a coronal thread core that is as solid as possible and preferably has the internal geometry of the implant interface to the prosthetic components.

Furthermore, as already explained, the bone hardness is usually softer towards the apical end of the implant. In this lower zone, the strongest cutting function should be by means of a cutting angle smaller than 90°, which then increases towards the coronal, i.e., is less aggressive. Since the bone becomes increasingly harder in the coronal zone, the cutting edges should cut into the bone structure less aggressively, but rather gently peel away, reducing the bone. In unfavorable bone conditions, this prevents the implant from snagging or sticking during reverse rotation or avoids excessive reverse torque.

The transition from cutting to compaction occurs continuously via the apical S-curve, which increasingly becomes an arc curve in the coronal direction. This advantageous course allows high mechanical stability to be achieved with optimum displacement and cutting function in the respective bone zone at the same time.

The angle of the cutting edge in relation to the side view of the cutting edge or the cutting area is advantageously between 20-80°. In this way, during the cutting process, the chip material is guided in the apical direction, in the tendentially softer bone area, in order to counteract excessive bone compaction. The cutting edge refers to the part of the circumferential thread in which the recess is made. The angle of attack is defined between the outer circumference of the cutting edge in the area of the cutting edge and the cutting edge.

By means of this angle of attack, the bone chips are transported in the apical direction during reverse rotation, i.e., into the bone zone, which tends to be softer. The configuration thus achieves additional densification of the local bone structure.

In order to ensure reliable advancement of the implant during screw-in, while at the same time providing a high and tissue-conserving compaction function, a zone ratio of a circumferential extent of a passive thread zone, in which no recess is present, to a circumferential extent of an active zone, in which a recess is present, is advantageously greater than 1. With this zone ratio, the primary screw-in function of the main thread is maintained, and the screw-in advance does not suffer from too wide and frequent interruptions or is not lost in unfavorable bone conditions.

Particularly preferably, the zone ratio increases from the implant tip in the coronal direction from a value greater than 1 to a value greater than 5, in particular 6. In this apical region, the screw-in function is particularly important, since the so-called apical primary stability requires an aggressive and preferably continuous self-tapping screw thread, with wide passive thread zones.

The recesses along the thread advantageously form at least one channel-shaped chip space (i.e., a space in which bone chips can collect) or channel extending from an implant tip to the thread outlet. The channel-shaped chip space forms both the geometric basis of the bone-compacting and bone-cutting shapes, which vary from apical to coronal, and the functional basis of bone chip transport and displacement. Chips of cut bone find a place there. In the design of spirally circulating channel-shaped chip spaces, they are also transported away apically, i.e., to where the bone is particularly cancellous and soft in most cases, in accordance with the direction of rotation, and contribute to compacting there. The chip space vertically interrupts the thread in its circular circulation and thus divides the passive and active thread zone and is the starting point of the compaction and cutting zone.

Furthermore, they form an element of mechanical retention in relation to rotational forces (torque). The bone, which is compacted when the implant is screwed into the bone in the displacement mode, curves back into these grooves by resetting to a large extent depending on the bone structure and, in addition to the friction between the bone and the implant, causes additional retentive anchorage in the form of anti-rotation protection, which leads to an increase in primary stability.

In a preferred embodiment, the dental implant has three channel-shaped chip spaces that are equally distributed in the circumferential direction for more uniform distribution of the active and passive thread zones and their rotational direction-dependent effect of compactions. In particular, this means that adjacent channel-shaped chip spaces each enclose an angle of 120° between them. A uniform circumferential distribution of three channel-shaped chip spaces and thus also of the compressing and cutting associated geometries, as described above, results in active interrupted thread zones (cutting and compressing areas) being in a ratio with passive radially maximally extended zones of the thread (screw-in guide and feed function into the bone) that is advantageous for most bone qualities.

With the focus on other bone qualities, e.g., extremely hard or extremely soft, other numbers of canal-shaped chip spaces or canals with the associated active elements can also find a useful application.

In another preferred embodiment, exactly two channel-shaped chip spaces are provided. With two channel-shaped chip spaces, there are advantages in favor of the larger active zone, as this can be designed deeper and more bone-friendly while at the same time having a favorable ratio of passive thread zone and active zone greater than 1.

Advantageously, a recess ratio between a maximum cutting edge radius, which corresponds to the radial distance of the cutting edge or a point, in particular the most distant point, of the cutting edge to the central axis of the dental implant, and a maximum recess radius or a maximum recess depth, which corresponds to the radial distance of the point of the recess that is closest to the central axis of the dental implant, decreases in the coronal direction, in particular from 1.7 to 1.0.

In a preferred embodiment, the respective channel-shaped chip space runs radially coiled in the thread for a more uniform distribution of the effect of compaction zones, cutting zones, chip intake over the circumference and depth of the implant bed. A uniformly circumferential, coiled distribution of channel-shaped chip spaces and thus of the compacting and cutting associated geometries has the advantage that in zones of different bone density, primarily near hard bone walls or lamellae, only one small active displacing or cutting implant zone interacts with the hard structure at any one time, and upon further rotation, the next small active zone becomes active at a different level with a time delay. Such a configuration distributes the insertion forces evenly and advantageously over the rotations during implant placement. Advantageously, the radial pitch of the respective channel-shaped chip space is between 15 mm and 30 mm per revolution of the thread. In this range, the distribution of the active and passive zones is favorably distributed, allowing uniform screwing-in and screwing-back of the implant without torque peaks in the respective direction of rotation.

In an alternative, preferred embodiment, the respective channel-shaped chip space runs straight in the thread, i.e., its radial pitch is zero.

Advantageously, the depth of the recesses decreases as seen from the apical end to the coronal end of the dental implant. The active elements (compaction area, cutting area, chip deflection geometries) must act less intensively in the coronal area than, for example, in areas closer to the apex, since the bone has already been prepared here by several previously inserted threads. Accordingly, they are designed more discreetly, which is accompanied by a decreasing depth of the recesses toward the coronal. This design is advantageous for most bone qualities. For special cases, however, the design with a constant depth of the recess and the associated active elements can also be used.

Due to the helical design of the channels/channel-shaped chip spaces, which run from apical to coronal, the bone tissue is deflected from top to bottom during screwing in. The helical design of the channels results in an angle of attack, which is responsible for the removal of the bone chips in the lateral and coronal direction during insertion and compaction. Furthermore, the chip-diverting surfaces of the cutting part are inclined in such a way that the chips are diverted in the apical direction during the backward rotation of the implant for the cutting process.

As the bone becomes more porous or cancellous (spongy) when viewed from top to bottom (in relation to the implant geometry from coronal to apical), the displaced bone or bone chips can thus be moved to areas where the density is lower. In this way, a beneficial distribution of the displaced bone tissue around the implant is achieved, increasing primary stability.

Advantageously, the respective thread has a constant pitch. The constant thread pitch produces a uniform high insertion feed rate without additional compaction of the bone structure as a result of a discontinuous pitch.

In a preferred embodiment, the dental implant has a single thread that has a pitch between 0.6-0.9 mm or 0.6-1.2 mm. A pitch between 0.6-0.9 mm has proven to be favorable from a bone physiological point of view and follows known scientific standards.

In a preferred, alternative embodiment, the dental implant has a double thread with a pitch between 1.2 mm and 1.8 mm or 1.2 mm and 2.4 mm. The design of a double or multiple thread increases the insertion speed of the implant without changing the spacing of the respective thread zones. With such a set-up, the physiological advantages of the thread pitch are maintained.

Advantageously, depressions are arranged or introduced in the cervical region of the implant, in particular at the implant neck, which are separated from each other in the radial circumferential direction. By interrupting the depressions in the radial direction, i.e., no circumferentially continuous grooves are formed, rotational locking of the dental implant is achieved when bone tissue has penetrated and/or grown into the depressions. In contrast to circularly uninterrupted grooves, which do not provide any rotation protection of the implant apart from friction with the bone, interrupted structures have the advantage of further mechanical rotation-inhibiting anchorage.

Preferably, such structures are realized at the implant neck which, compared to regularly distributed frame-like structures remaining in the implant neck diameter, represent recesses or depressions into which the bone is reinserted after previous displacement thanks to the limited elastic resilience of the bone. The bone bed in this area is undersized in diameter, so that when the neck area of the implant is inserted, slight displacement takes place there and the bone inserts itself into the recesses after completion of implant placement, i.e., when rotation stops, due to the resilience, thus providing retention and increasing primary stability.

In the further course of implant healing, these depressions further enable hemorrhage into this area and thus osteoblast activity and subsequent ossification.

The attachment of the described elements in the area of the implant neck can take place in several designs, for example but not exclusively in the form of narrow elongated depressions, round, ellipsoid, rhomboid or square. They can be placed circularly around the implant neck in one or more rows.

A balanced distribution over the circumference and height of the implant neck is considered advantageous in view of the possible different qualities of the bone in these areas.

In particular, in combination with the described combination of cutting and compaction structures, a high primary stability can be achieved, since all forces or moments acting on the implant can be distributed or transmitted both in the area of the thread and in the area of the implant neck and counteract rotational movements of the inserted implant under load. In addition, both at the implant neck and in the area of the implant thread, integration of the implant into bone is made possible in a gentle manner. The bone is not simply cut or shredded away, as is the case with self-cutting implants, which destroys bone cells or accruals. Rather, the elasticity of the bone is utilized, which is displaced outward as well as into the threads, initially providing primary stability to the implant and then allowing the implant to integrate organically as healing progresses.

Due to the special main thread geometry described, which allows for degressive displacement when screwing in and cutting of the bone as needed when screwing back, undersized predrilling can be used, which is what makes the described effects of the coronal anti-rotational elements during insertion and later the organic ingrowth of the bone into the depressions in the coronal area possible in the first place.

The combination of the described features of the threaded area of the implant and the implant neck, namely the design as a displacing/cutting main thread and the circularly interrupted geometry at the implant neck, are to be considered particularly advantageous, as they both contribute synergistically with the previously described complementary effects to the achievement of a high primary stability during the insertion of the implant.

In a preferred embodiment, the depressions are formed as radially extending notches. In principle, the radial notches should be located in one to several staggered rows, whereby the distribution can vary according to the respective implant diameter. To prevent the coronal neck from being weakened too much in its cross-section, the notch depth should be between 0.08 mm and 0.15 mm and the notch height between 0.20 mm and 0.40 mm. The number of notches depends on the neck diameter, with the radial spacing of the non-notched zone being between 0.10 mm and 0.30 mm. This results in a number of 9 notches for a neck diameter of Ø 4.7 mm, for example. In contrast to the circumferential microthreads or microgrooves used in implantology, the area of the depressions is interrupted here by ‘bars’ left standing, so that rotation-inhibiting elements are available for the bone slowly pushing back after insertion, in addition to intrusion inhibition, and thus higher primary stability can be achieved.

Advantageously, the depressions or notches are arranged in several, in particular radially offset in pairs, zones, in particular rows, which further improves the rotational force compensation. Since the bone generally has zones of different quality, a particularly even distribution of the anti-rotationally acting features to the corresponding bone areas is thus achieved. Furthermore, the mechanical stability of the implant neck is increased by the staggered distribution.

In an alternative preferred embodiment, the recesses are formed as rhombic recesses. The rhombic design with larger, smooth, rhombiod circularly interrupted recesses enables easier cleaning of this area using suitable instruments, e.g., scalers or curettes, in cases where these are not covered by the bone for individual medical reasons. The arrangement and design of the rhombic recesses are preferably such that cleaning with curetting instruments is possible.

Preferably, the rhombic depressions are arranged inclined to a central axis of the dental implant. Due to the inclined course (direction like implant thread pitch, but steeper) of the rhombic interruption geometries, an apically directed insertion force is generated on the implant during implant insertion by the insertion direction, which favors the insertion process.

The lateral inclination of the rhombi increases in relation to the implant axis or central axis of the dental implant, in relation to the direction of rotation of the implant (thread screwing direction) during insertion, from the front-bottom obliquely to the back-top (coronal), preferably running from the bottom left obliquely to the top right (coronal) in the case of a clockwise implant to be screwed in. This supports a downward (apical) movement of the implant during insertion due to the friction of the bars delimiting the recesses with the bone.

The recesses are advantageously between 0.08 mm and 0.15 mm deep, in particular 0.11 mm. This takes into account the resilience of the bone on the one hand and the preservation of the mechanical stability of the implant walls on the other. The indentations must not be too deep in order to further maintain the mechanical stability of the implant neck. Too deep notches would severely weaken the cross-section of the implant in the most highly loaded zone, since the reduction in cross-section would reduce the section modulus of the implant body in the zone and thus also reduce the flexural strength. Furthermore, deep notches would make the implant additionally more susceptible to fracture, since the notch effect of deep notches is disadvantageous. With the values determined, an advantageous solution could be found.

In an alternative variant, the invention relates to a dental implant with a prosthetic interface in its cervical region, a core and at least one thread extending from the cervical region to an opposite apical region, wherein in the cervical region, in particular at the implant neck, depressions are arranged which are separated from one another in the radial circumferential direction, for example, but not exclusively, in the form of narrow elongated depressions, round, ellipsoid, rhomboid or square.

Advantageously, the recesses are arranged in several zones, in particular radially offset rows in pairs.

In a preferred embodiment, the recesses are formed as radially extending notches.

In another preferred embodiment, the recesses are rhombic recesses.

Preferably, the rhombic depressions are arranged inclined to a central axis of the dental implant.

The recesses are preferably between 0.08 mm and 0.15 mm deep, in particular 0.11 mm.

The advantages of the recesses mentioned in connection with the implant with recesses described further above also apply to this variant of the invention, where applicable.

The advantages of the invention lie in particular in the fact that a dental implant is provided which, due to its cutting and compacting structures, is particularly suitable for immediate restoration and provides reliable primary stability.

### BRIEF DESCRIPTION OF THE DRAWINGS

A preferred embodiment of the invention is explained in more detail below with reference to a drawing. Therein show in highly schematized representation:

FIG. 1 a dental implant in a first preferred embodiment;

FIG. 2 a dental implant in a second preferred embodiment;

FIG. 3 the dental implant shown in FIG. 2 with the outer contour drawn in;

FIG. 4 the dental implant shown in FIG. 2 with the thread core contour drawn in;

FIG. 5 the dental implant shown in FIG. 2 in a vertical section looking from apical to coronal;

FIG. 6 a detail enlargement from FIG. 5;

FIG. 7 the dental implant shown in FIG. 2 with section drawn in;

FIG. 8 the cutout of FIG. 7;

FIG. 9 the dental implant shown in FIG. 2 with five sections drawn in;

FIG. 10 the cut with number 1 from FIG. 9;

FIG. 11 the cut with number 2 from FIG. 9;

FIG. 12 the cut with number 3 from FIG. 9;

FIG. 13 the cut with number 4 from FIG. 9;

FIG. 14 the cut with number 5 from FIG. 9;

FIG. 15 a section through the dental implant shown in FIG. 2;

FIG. 16 a cutout from of FIG. 15;

FIG. 17 a section through the dental implant shown in FIG. 2;

FIG. 18 a dental implant in another preferred embodiment with s section drawn;

FIG. 19 the section from FIG. 18;

FIG. 20 a dental implant in another preferred embodiment with s section drawn;

FIG. 21 the section from FIG. 20;

FIG. 22 a dental implant in another preferred embodiment with a section drawn, and

FIG. 23 the section from FIG. 22.

Identical parts are marked with the same reference signs in all figures.

### DETAILED DESCRIPTION OF THE DRAWINGS

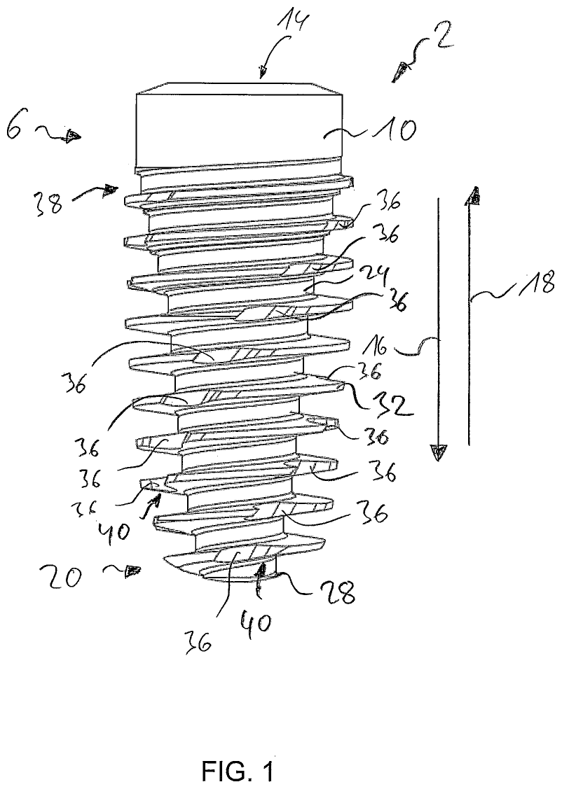

A dental implant 2 shown in FIG. 1 comprises an implant neck 10 with a prosthetic interface 14 in a cervical region 6. A core 24 of the implant runs from the cervical region 6 to the apical region 20 in the apical direction 16 (opposite to this is the coronal direction 18), which tapers into an implant tip 28 in the apical region 20. The dental implant 2 has a thread 32 formed as an external thread. The thread 32 has a plurality of recesses 36. The recesses 36 form three channel-shaped chip spaces 40 in the thread 32, each of which has a radial pitch of 15 mm per revolution in the illustrated embodiment. The respective channel-shaped chip space 40 extends from the implant tip 28 to a thread run-out 38.

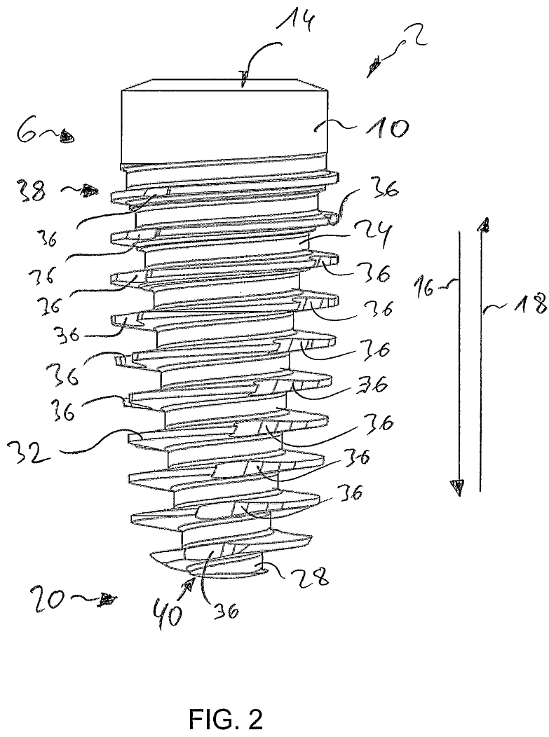

In FIG. 2, a dental implant 2 is shown in a further embodiment. The dental implant according to FIG. 2 differs from the dental implant 2 according to FIG. 1 in the radial pitch of the channel-shaped chip spaces 40, which is 30 mm per revolution in the dental implant 2 shown in FIG. 2.

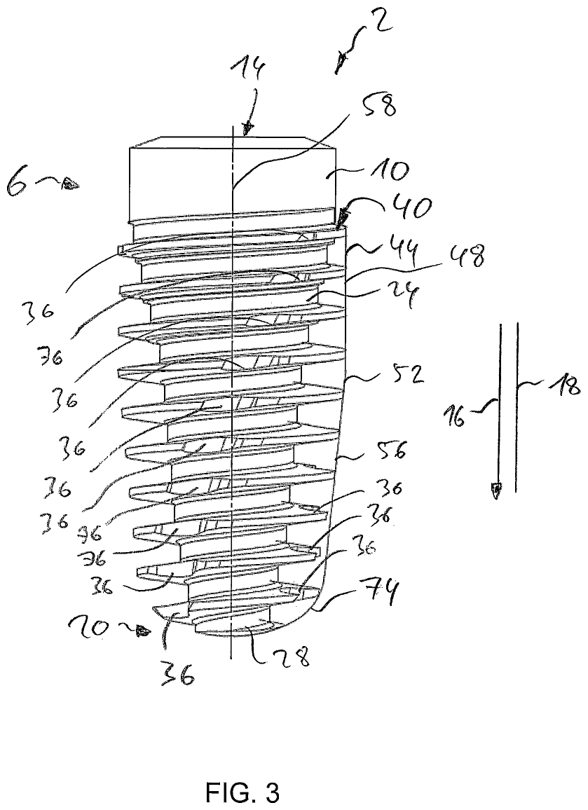

In FIG. 3, the dental implant 2 as shown in FIG. 2 is shown in a rotated position relative to FIG. 2, with a threaded outer contour 44 drawn on the right side. In a first threaded region 48, which is adjacent to the cervical region 6, the thread 32 has a substantially constant outer contour, meaning that the radial extent of the thread 32 is substantially constant in this region. In a second threaded region 52, which adjoins the first threaded region 48 in the direction of the implant tip 28, the constant outer contour merges in a transition into an adjoining third threaded region 56, in which the outer contour tapers in the direction of the implant tip 28, in particular conically.

In an adjoining fourth threaded region 74, there is a sharp tapering of the outer contour towards the implant tip 28. This allows the implant to be inserted advantageously into anatomically disadvantageous bone regions (e.g., extraction sockets), since a more pointed shape of the apical part can be inserted more deeply into a predrilled bone cavity and subsequently allows better guidance when screwing in the implant. Further shown in FIG. 3 is a central axis 58 of the dental implant 2, which is essentially an axis of symmetry of the core 24.

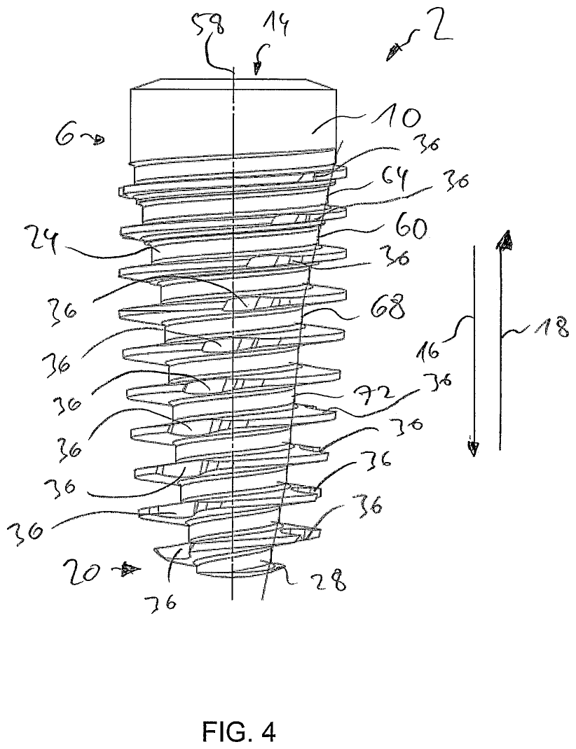

In FIG. 4, the dental implant 2 is shown according to FIG. 3 with the outer core contour 60 of the core 24 drawn in, which runs along the core radius. Starting from the cervical region 6 towards the apical region, the core diameter tapers, in particular conically, with a first slope. In a second core region 68 adjoining it in the apical direction, the slope of the core diameter changes, so that in a third core region 72 adjoining it in the apical direction, the core diameter tapers further, but with a smaller slope than in the first core region. In the apical direction, the core diameter tapers in the third core region 72 with the same pitch or with increasing pitch.

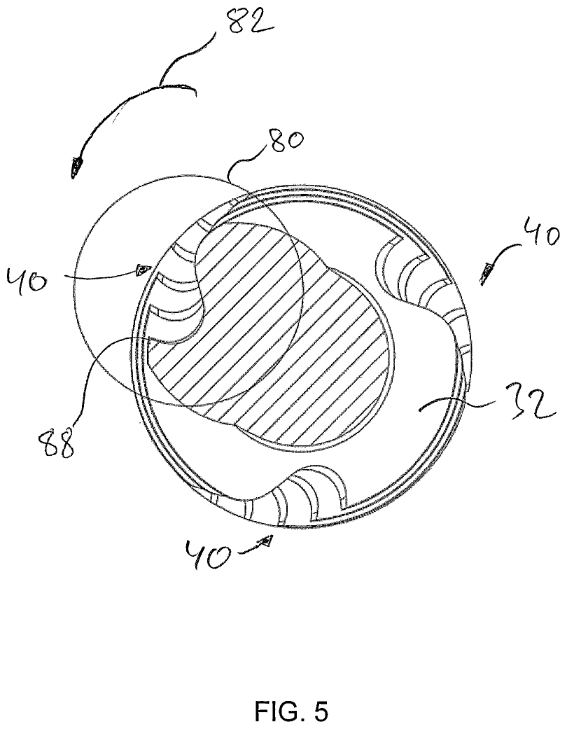

In FIG. 5, a section through the implant according to FIG. 2 is shown, starting from the implant tip 28 in the direction of the implant neck 10, i.e., in coronal direction 18. In this figure, the three radially wound channel-shaped chip spaces 40, which are formed by the recesses 36 in the thread 32, are clearly visible.

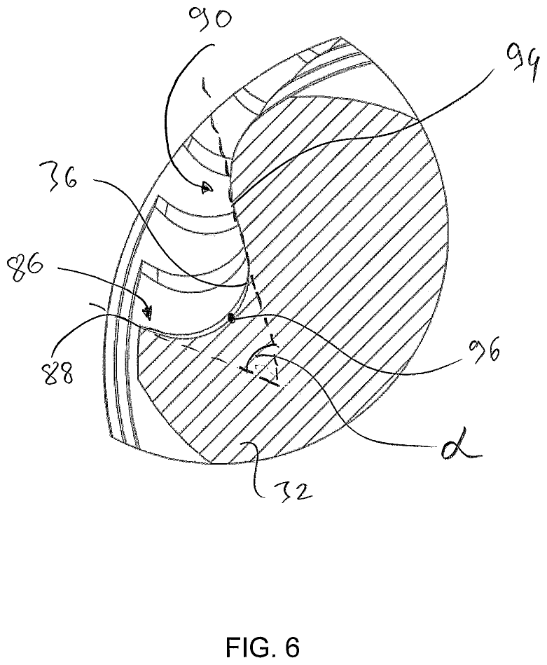

A section 80 from FIG. 5 is shown enlarged in FIG. 6. The respective recess 36 in the thread 32 has a cutting area 86, at the edge of which a cutting edge 88 is formed on the circumference of the gear. Adjacent to or adjacent to the cutting region 86 is a compaction region 90. The cutting region 86 and the compaction region 90 form a substantially S-shaped curve 94 in the thread 32, which resembles a sinusoidal contour. The radial extent of the recess along the thread circumference denotes the active thread zone or zone SU-A. The wider this is along the circumference, the longer the cutting zone 86 and/or the compaction zone 90 are drawn. The important factor for the advantageous ratio is a sufficiently passive zone to ensure reliable advancement of the implant during screwing in, while at the same time providing a high compaction function that is gentle on the tissue. The ratio of passive thread zone GU-A and active zone SU-A should be >1 apically and increase further to 6 coronally.

The compaction area 90 is rounded and, viewed perpendicular to the center axis 58 of the dental implant 2, has a positive, monotonically decreasing gradient from a point 96 of maximum recess depth nearest in the radial direction of the center axis 58. The thread flanks are vertically interrupted one or more times in their circular circulation. The rise of the thread flanks from the interruptions back to the full thread circumference takes place on one side in the form of a fan-shaped geometry 90, 94, which is rounded in the course, compacting bone, and on the opposite side in the form of a cutting geometry 86, 88. In this case, the compacting side is moved against the bone to be machined in the insertion direction (clockwise) of the implant and the cutting side is moved against the bone to be machined in the extraction direction (counterclockwise). By changing the direction of rotation, it is thus possible to alternate between bone compaction and bone cutting, thus providing the individual bone surrounding the implant with optimum primary stability.

The cutting area 86 is rounded and, viewed perpendicular to the center axis 58 of the dental implant 2, has a positive, monotonically decreasing slope from a point 96 of maximum recess closest in radial direction to the center axis 58 in the direction of the cutting edge 88. In the course of the thread, this cutting edge 88 is opposite the compaction geometry 90, 94 located on the other side of the interruption/recess.

An opening angle α of the respective recess 36 is defined as an angle between a tangent to the edge of the cutting region at the outer region of the thread 32 and a region of the contour 94 in the compaction region 90 with a substantially constant pitch. The opening angle α is an acute angle in the illustrated preferred embodiment and is 56° in the present preferred embodiment.

When the dental implant 2 is screwed into the bone in a direction of insertion rotation 82, the surrounding bone is compacted with the aid of the compaction area 90. The rounded design of the compaction area 90 shown enables an initially progressive, then degressive and thus bone-friendly or bone-preserving compaction of the bone. Rotation by the same angle leads to more compaction in a first step, when the bone is still soft and uncompacted, than in a subsequent second step, when the bone is already pre-compacted. When rotating the dental implant 2 in the opposite direction to the insertion rotation direction 82 or insertion direction, the respective cutting edge 88 cuts into the bone tissue.

As described above, during the insertion of the dental implant 2, while it is rotated clockwise, the bone is purposefully compressed or compacted/compacted with the help of the compaction area 90 and simultaneously pressed vertically into the spaces of the thread 32. However, if the bone is not flexible enough, but too hard, too high a torque would be required for screwing it in. In this case, the bone can be prepared for further insertion by precutting or cutting it using the cutting edges 88 by rotating the dental implant 2 counterclockwise, in particular for about one third of a complete rotation.

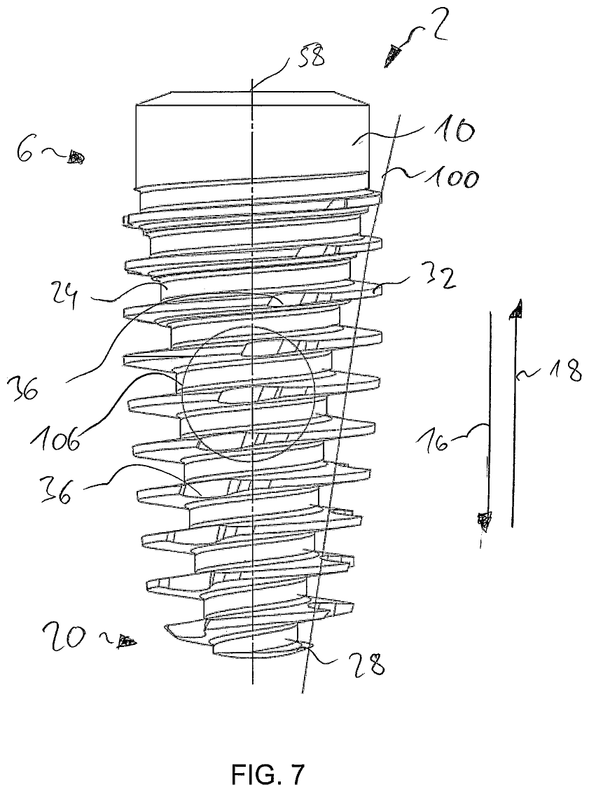

In FIG. 7, the dental implant according to FIG. 2 is shown with a channel contour 100, which is drawn in a channel 40 in each case through the radially innermost point, i.e., point 96, of a recess. It can be seen that in the apical direction, the deepest point of the recess (point 96) moves closer to the central axis and towards the coronal, the deepest point (point 96) is increasingly less deep. For the sake of clarity, not all recesses in this and the other figures are always given the reference sign 36.

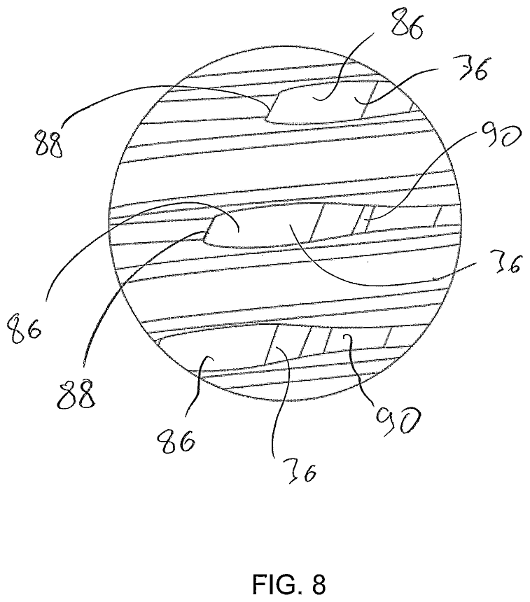

A section 106 of FIG. 7 is shown enlarged in FIG. 8. This shows three recesses 36 with cutting areas 86 and compaction areas 90.

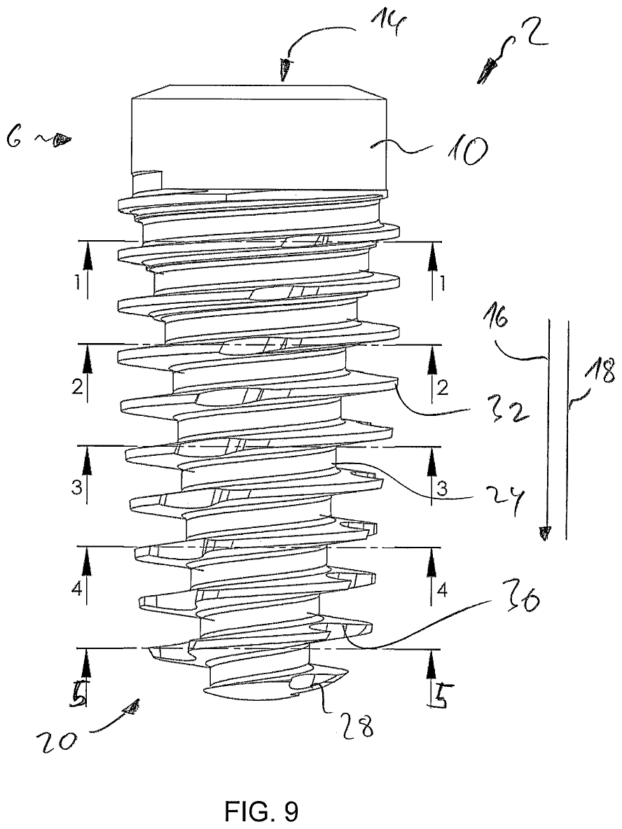

In FIG. 9, the dental implant 2 is shown according to FIG. 2, with 5 different cuts drawn, each marked with the numbers 1, 2, 3, 4, 5. The cuts with the numbers 1 to 5 are arranged in apical direction 16, so that cut 1 is performed closest to the implant neck 10 and cut 5 is closest to the implant tip 28.

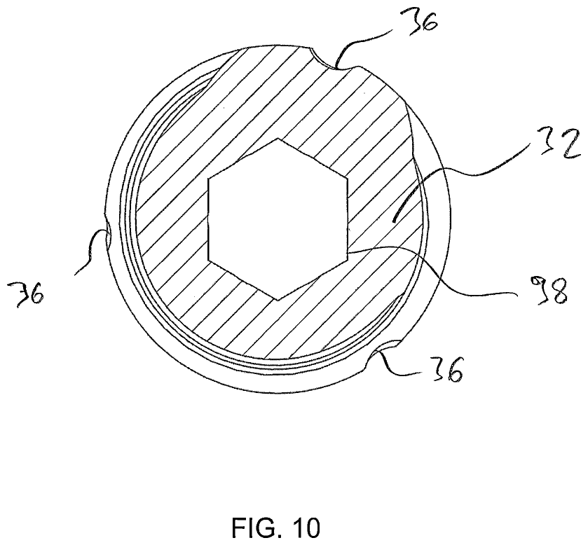

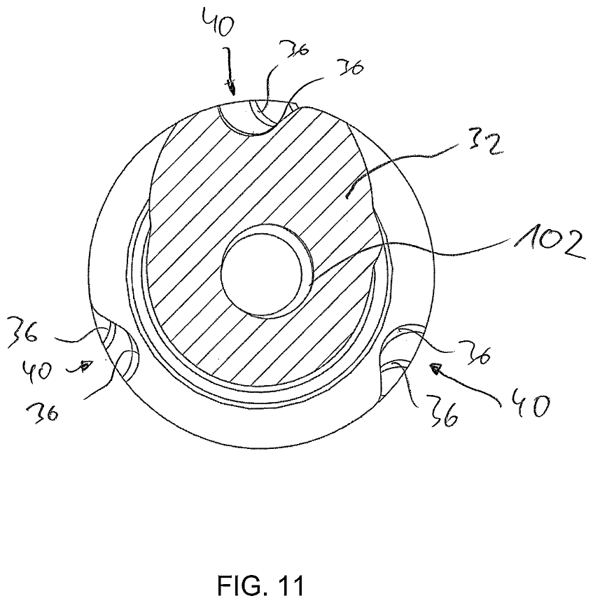

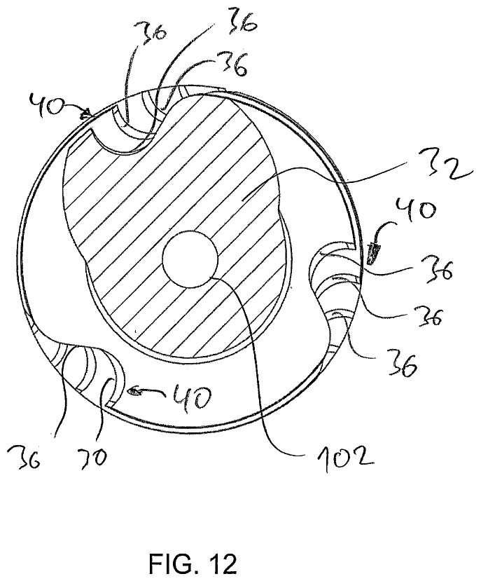

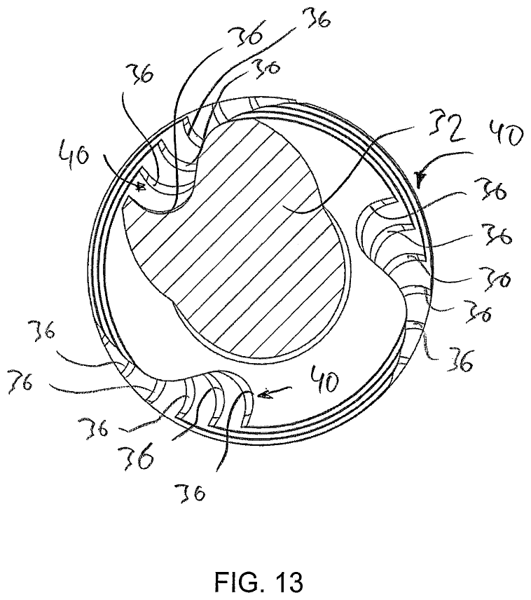

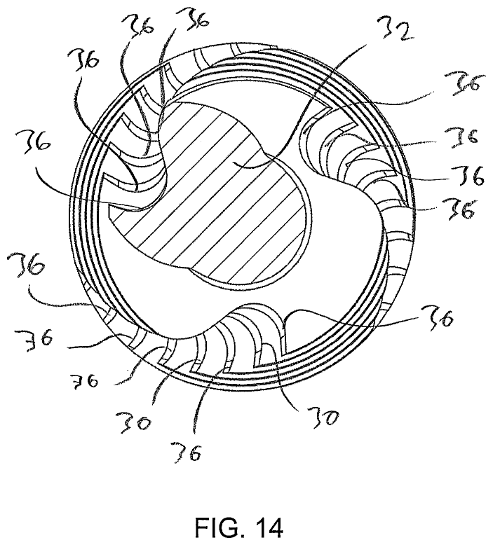

The five sections are shown in FIGS. 10-14, where FIG. 10 shows the section numbered 1, FIG. 11 shows the section numbered 2, FIG. 12 shows the section numbered 3, FIG. 13 shows the section numbered 4, and FIG. 14 shows the section numbered 5. In the first section 98 shown in FIG. 10, an implant interface 98 for an abutment can be seen, which is a hexagonal section. In FIGS. 11 and 12 (second and third sections), a hole is visible in core 24.

From the sequence of sections 1 to 5 in FIGS. 10-14, it can be seen that the recesses 36 become deeper when viewed in the apical direction 16. They have the least depth in section 1 and the greatest depth in section 5.

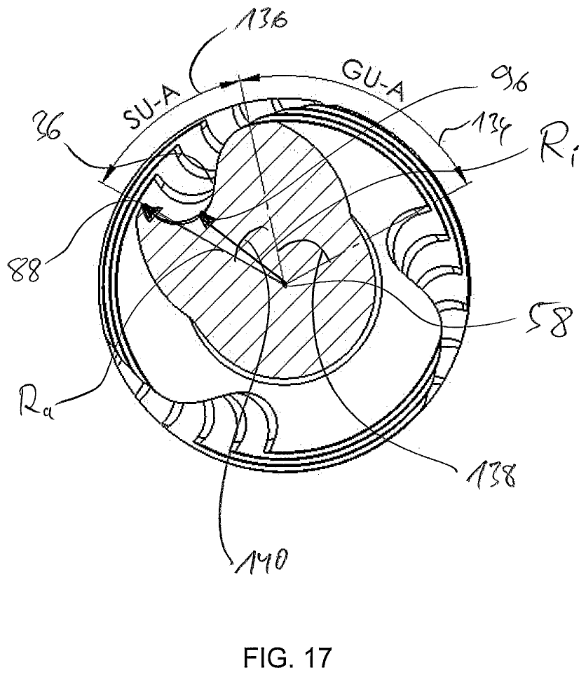

This progression of recess depth is quantified below using two radii Rₐ, Rᵢ, drawn in FIG. 17, which represents the fourth cut or cut number 4. The outer radius Rₐ measures radially the distance of the cutting edge 88 or a point of the cutting edge 88 from the central axis 58 of the dental implant 2 (maximum cutting edge radius). The inner radius Rᵢ measures the radial distance of the point 96 to the center axis 58 of the dental implant 2 (maximum recess depth).

The minimum/maximum depth of the recesses 36 in the illustrated embodiment example is between 0.0 mm and 0.80 mm. Here, the minimum/maximum depth essentially denotes the difference between the two radii Rₐ and Rᵢ. The ratio between the maximum cutting edge radius (Rₐ) and the maximum recess depth (Rᵢ) in relation to the implant centerline or centerline 58 of the dental implant is between 1.7 apically to 1.0 coronally.

The following table shows the two radii Rₐ and Rᵢ and the ratio Rₐ/Rᵢ for the dental implant 2 shown in FIG. 9.

| Cut number | Rₐ | Rᵢ | Rₐ/Rᵢ |
|---|---|---|---|
| 1 | 2.60 | 2.39 | 1.09 |
| 2 | 2.60 | 2.07 | 1.25 |
| 3 | 2.46 | 1.79 | 1.38 |
| 4 | 2.29 | 1.52 | 1.50 |
| 5 | 2.01 | 1.24 | 1.62 |

As can be seen from the table, both radii essentially decrease in the apical direction 16, and the ratio between Rₐ and Rᵢ increases in the apical direction 16.

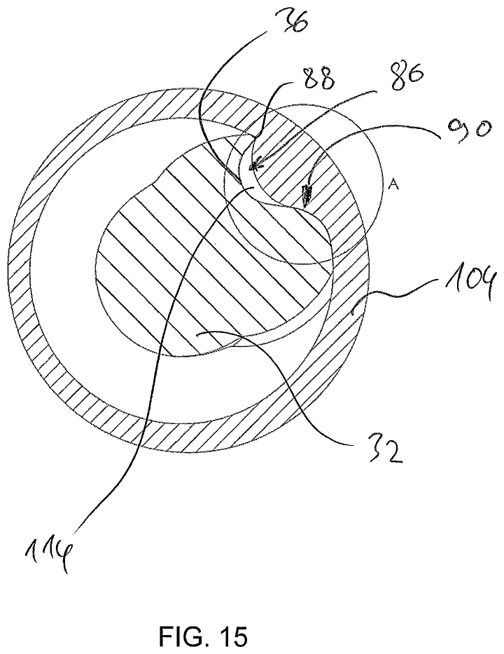

In FIG. 15, a section (section 4, see FIG. 13) through the dental implant 2 is shown. Further schematically shown is the bone tissue 104 surrounding the dental implant 2 as well as a bone tissue-free space 114 in the recess 36. The illustration of FIG. 15 shows the dental implant 2 in an at least partially screwed-in state in the jawbone.

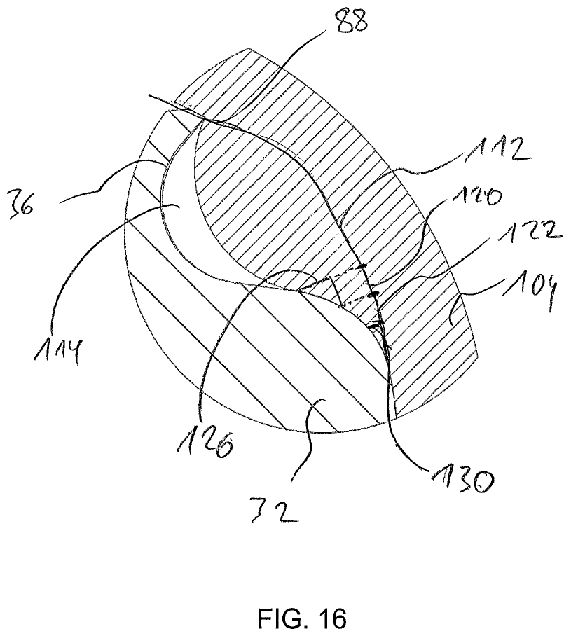

In FIG. 16, the section indicated in FIG. 15 is shown enlarged. Along an imaginary circumferential line 112 of the thread 32, a first arc segment length 120 and a second arc segment length 122 are drawn, both of equal length. Corresponding to the first arc segment length 120 is a first depth 126; corresponding to the second arc segment length 122 is a second depth 130. The two depths 126, 130 are each defined as the maximum distance from the compaction area 90 of a line which runs essentially parallel to the respective arc segment length 120, 122, the length of which corresponds essentially to the respective arc segment length 120, 122 and which, at its end facing away from the cutting area 86, touches the thread or starts there.

As can be seen with the aid of FIG. 16, the same arc segment length 120, 122 leads to greater compaction or compacting of the bone tissue 104 in a first step (depth 126) when screwing the dental implant 2 into the jawbone than in a subsequent second step (depth 130) when the bone tissue 104 is already pre-compacted. When screwing the dental implant 2 into the bone, the first step precedes the second step in the respective bone tissue. This results in a degressive compaction of the bone tissue 104.

The dental implant 2 is designed to ensure reliable advancement during screw insertion, while at the same time providing a high and tissue-conserving compaction function. For this purpose, a sufficiently passive area corresponding to a passive thread zone GU-A is provided. The passive thread zone GU-A corresponds in an area of the thread 32 in the circumferential direction, in which no recess 36 is present. The passive threaded zone GU-A has a first circumferential portion 134 and a first opening angle 138. The active threaded zone SU-A corresponds to an area of the thread 32 in the circumferential direction in which a recess 36 is present. The active thread zone SU-A has a second circumferential portion 136 and a first aperture angle 140. Both zones can be characterized by the corresponding aperture angle 138, 140 and circumferential swept arc length and circumferential portion, respectively. The ratio of passive thread zone GU-A and active zone SU-A is advantageously >1 and increases in coronal direction 18 up to 6.

The following table shows for sections 1 to 5 according to FIG. 9 the chip space circumference portion of the active zone SU-A as opening angle in degrees and circumference portion in mm and the thread circumference portion as opening angle in degrees and circumference portion in mm. In the last column, the ratio of the two angles or circumferential fractions is given in each case.

| | SU-A | SU-A | GU-A | GU-A | |
|---|---|---|---|---|---|
| Cut | Opening | Perimeter | Opening | Perimeter | |
| number | angle | share | angle | share | Ratio |
| 1 | 18.63 | 0.27 | 104.88 | 1.52 | 5.63 |
| 2 | 31.99 | 0.46 | 90.52 | 1.31 | 2.83 |
| 3 | 41.63 | 0.57 | 80.56 | 1.10 | 1.94 |
| 4 | 48.34 | 0.61 | 73.67 | 0.93 | 1.52 |
| 5 | 47.98 | 0.54 | 74.64 | 0.83 | 1.56 |

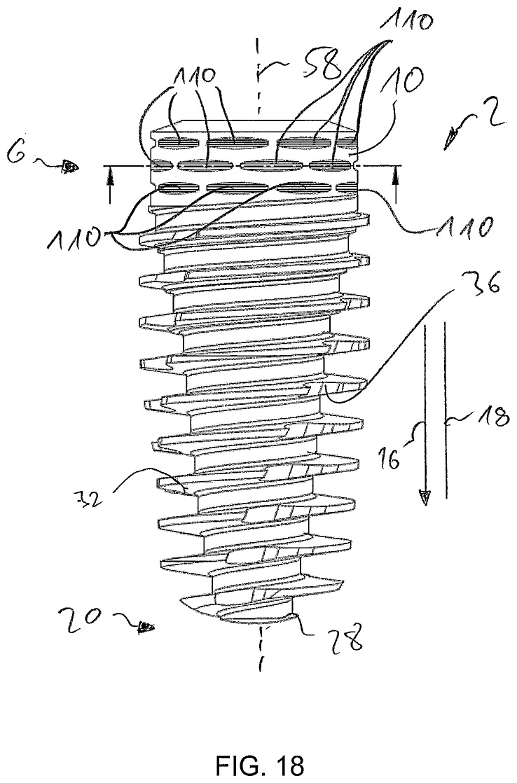

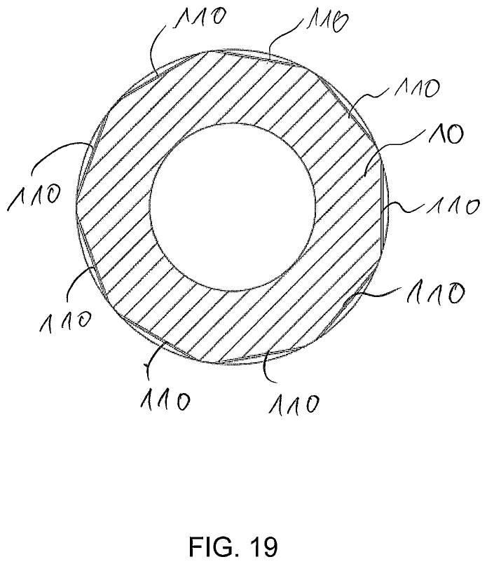

In FIG. 18, a dental implant 2 is shown in a further preferred embodiment. In the cervical region 6 of the dental implant, in this case in the implant neck 10, depressions 110 are provided in which the radial extent of the implant neck 10 is reduced in certain regions. A section shown in FIG. 18 is shown in FIG. 19, in which the area-wise radial reduction of the implant neck 10 can be seen. In the illustrated embodiment example, the depressions 110 have a depth, in particular a maximum depth, of 0.11 mm. The bar-like geometries separating the depressions 110 (remaining vertically and horizontally between the depressions 110) preferably remain within the outer circumference of the cervical implant diameter, or lie between this and at least slightly above the depth of the depressions 110, to ensure, that a rotation-preventing (vertical) and intrusion-preventing (horizontal) element of the implant is available to the flexible bone, which slowly pushes itself back into the depressions after mechanical displacement during insertion, to increase primary stability.

As can be seen in FIG. 18, the depressions 110, which are formed in particular as micro pits, are arranged in three rows in the axial direction (viewed along the center axis 58 of the dental implant). Thereby, in projection parallel to the axial direction or center axis 58, depressions of 110 from two adjacent rows only partially overlap. This ensures an even distribution of the anti-rotational and intrusion-inhibiting auxiliary elements over the cervical bone areas.

The indentations 110 must not be too deep in order to further maintain the mechanical stability of the implant neck 10. Too deep notches would severely weaken the cross-section of the dental implant 2 in the most highly loaded zone, since the reduction in cross-section would reduce the section modulus of the implant body or core 24 in the zone and thus also reduce the flexural strength. Further, deep notches would make the dental implant 2 additionally more susceptible to fracture, since the notch effect of deep notches is disadvantageous.

Since the bone usually has zones of different quality, a particularly even distribution of the anti-rotational features to the corresponding bone areas is achieved in this way. Furthermore, the mechanical stability of the implant neck 10 is increased by the staggered distribution.

Whereas conventional grooves in the cervical region 6 of a dental implant 2 have only a slight inhibition of rotation in soft bone, the depressions 110 described allow bone tissue to penetrate or grow into them, thus achieving an inhibition of rotation. This is advantageous since chewing movements on surfaces inclined to each other also introduce rotational forces into the implant or dental implant 2.

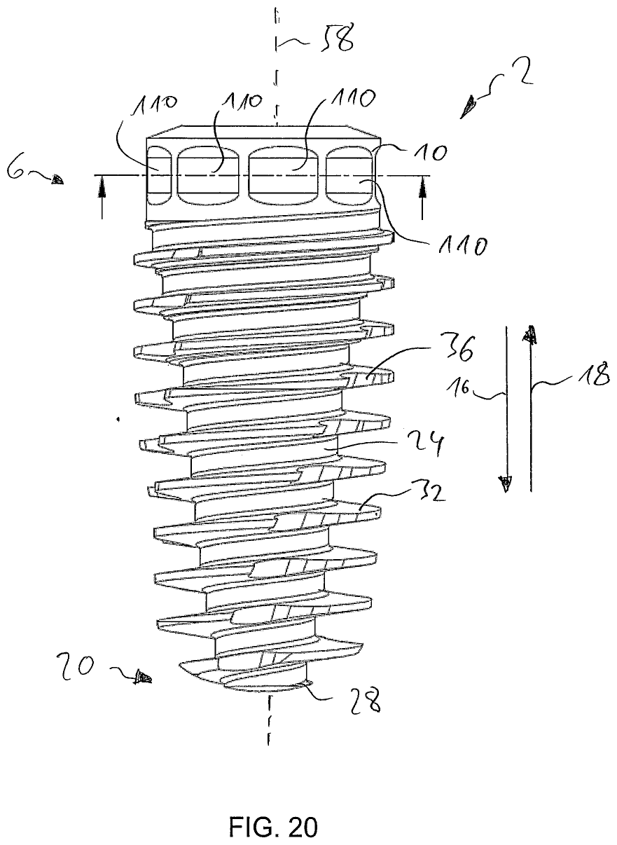

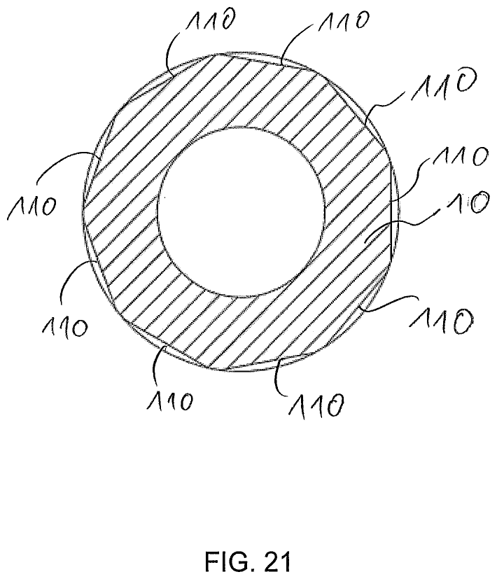

A dental implant 2 in another preferred embodiment is shown in FIG. 20, with a section through the dental implant 2 shown in FIG. 21. The dental implant 2 shown in FIG. 20 has rhombic depressions 110. The axes of symmetry of the rhombic depressions are parallel or perpendicular to the central axis 18 of the dental implant 2. The rhombic design with larger smooth rhombiods circularly interrupted recess allows easier cleaning of this area by means of suitable instruments, e.g., scalers or curettes, in cases where they are not covered by bone for individual medical reasons.

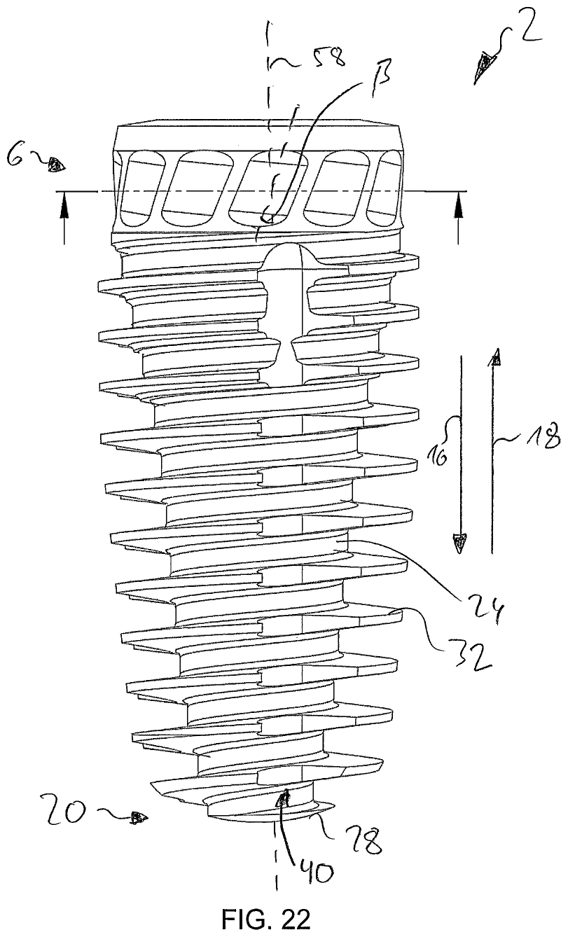

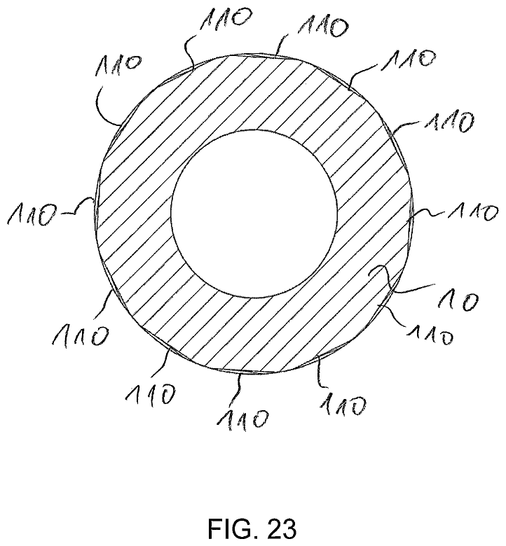

A dental implant 2 in another preferred embodiment is shown in FIG. 22, wherein a section through the dental implant 2 from according to FIG. 22 is shown in FIG. 23. The dental implant 2 as shown in FIG. 23 has rhombic depressions 110. The longer axis of symmetry of the rhombic depressions have an angle 13 to the central axis 58 of the dental implant 2, which is preferably between 5° and 30°.

The lateral inclination of the rhombuses or rhombic depressions 110 is preferably inclined from the lower left to the upper right with respect to the implant axis or central axis 58 of the dental implant in order to support a downward (apical) movement of the dental implant 2 during insertion due to the friction of the bars bounding the recesses with the bone when the dental implant 2 is rotated in a clockwise direction.

In the dental implant 2 shown in FIG. 22, the channel-shaped chip spaces 40 run parallel to the central axis 58. The embodiments of the implant neck 10 with recesses 110 shown in FIGS. 18-23 can also be combined with the depicted implant variants with obliquely running or radially wound channel-shaped chip spaces 40 and are covered by the invention.

### LIST OF REFERENCE SIGNS

2 dental implant
6 cervical area
10 implant neck
14 prosthetic interface
16 apical direction
18 coronal direction
20 apical area
24 core
28 implant tip
32 thread
36 recess
38 thread outlet
40 channel-shaped chip space
44 thread outer contour
48 first thread area
52 second thread area
56 third thread area
58 center axis
60 core outer contour
64 first core area
68 second core area
72 third core area
74 third thread area
80 cutout
82 insertion direction of rotation
86 cutting area
88 cutting edge
90 compaction area
94 S-shaped curve
96 point
98 implant interface
100 channel contour
102 bore
104 bone tissue
106 cutout
110 recession
112 circumference line
114 bone tissue free space
120 first arc segment length
122 second arc segment length
126 first depth
130 second depth
134 first circumference part
136 second perimeter part
138 first opening angle
140 second opening angle
α opening angle
β angle
GU-A passive thread zone
SU-A active thread zone

1. A dental implant having a prosthetic interface in its cervical region, a core and at least one thread extending from the cervical region to an opposite apical region, the thread having recesses on which a cutting edge for cutting bone is arranged, the respective cutting edge being arranged in the direction of the thread on the rear side of the recess,
wherein the respective recess has a cutting region at which the cutting edge is arranged and a compaction region adjacent to the cutting region for compacting bone tissue.

2. The dental implant of claim 1, wherein the compaction region is rounded and, viewed perpendicular to a central axis of the dental implant from a nearest point in radial direction of maximum recess depth, comprises an S-curve starting from the concavity located there.

3. The dental implant of claim 2, wherein the opening angle of the respective recess is an acute angle.

4. The dental implant of claim 2, wherein the cutting region is built rounded and, viewed perpendicularly to a central axis of the dental implant from a point of maximum recess nearest in the radial direction of the central axis in the direction of the cutting edge, has a contour with a constant radius which merges into a straight line section.

5. The dental implant of claim 1, wherein the angle of the respective cutting edge relative to the tangent of the outer diameter of the thread is between 70-150°.

6. The dental implant of claim 1, wherein the angle of incidence of the cutting edge relative to the side view of the cutting edge is between 20-80°.

7. The dental implant of claim 1, wherein a zone ratio of a circumferential extent of a threaded passive zone in which there is no recess to a circumferential extent of an active zone in which there is a recess is greater than 1.

8. The dental implant of claim 7, wherein the zone ratio from the implant tip in coronal direction increases from a value greater than 1 to a value greater than 5.

9. The dental implant of claim 1, wherein a recess ratio between a maximum cutting edge radius, which corresponds to the radial distance of the cutting edge or of a point, in particular the most distant point, of the cutting edge to the central axis of the dental implant, and a maximum recess depth, which is the radial distance of the point of the recess that is closest to the central axis of the dental implant in the coronal direction, is between 1.7 to and 1.0.

10. The dental implant of claim 1, wherein the recesses along the thread form at least one channel-shaped chip space extending from an implant tip to the thread run-out.

11. The dental implant of claim 10, having three channel-shaped chip spaces which are equally distributed in the circumferential direction.

12. The dental implant of claim 10, wherein the respective channel-shaped chip space extends radially wound in the thread.

13. The dental implant of claim 10, wherein the radial pitch of the respective channel-shaped chip space is between 15 mm and 30 mm per revolution of the thread.

14. The dental implant of claim 1, wherein the depth of the recesses decreases as seen from the apical end to the cervical end of the dental implant.

15. The dental implant of claim 1, wherein the respective thread has a constant pitch.

16. The dental implant of claim 15, with a single thread having a pitch between 0.6-1.2 mm.

17. The dental implant of claim 15, having a double thread with a pitch between 1.2 mm and 2.4 mm.

18. The dental implant of claim 1, wherein depressions are arranged in the cervical region, which are separated from one another in the radial circumferential direction.

19. The dental implant of claim 18, wherein the depressions are arranged in several zones.

20. The dental implant of claim 18, wherein the depressions are formed as radially extending notches.

21. The dental implant of claim 18, wherein the depressions are formed as rhombic depressions.

22. The dental implant of claim 21, wherein the rhombic depressions are arranged inclined to a central axis of the dental implant.

23. The dental implant of claim 18, wherein the depressions are between 0.08 mm and 0.15 mm.
